(19) United States
(12) Patent Application Publication
(10) Pub. No.: US 2007/0190239 A1
(43) Pub. Date: Aug. 16, 2007

(54) Method of forming serial or parallel fuel cell units

(76) Inventors: Hsi-Ming Shu, Taipei (TW); Tsang-Ming Chang, Taipei (TW); Feng-Yi Deng, Taipei (TW); Ko-Chen Shen, Taipei (TW)

Correspondence Address: G. LINK CO., LTD, 3550 Bell Road, MINOOKA, IL, 60447, US

(21) Appl. No.: 11/353,059

(22) Filed: Feb. 14, 2006

(51) Int. Cl. B05D 5/12; H01B 13/00

(52) U.S. Cl. 427/115; 216/13

(57) ABSTRACT

A method of forming serial or parallel fuel cell units is provided and comprises the following steps. A step is to provide a cathode substrate, an anode substrate and at least a membrane electrode assembly (MEA). A step is to form at least a cathode current collection circuitry and at least a first contact on the same surface of the cathode substrate, wherein the cathode current collection circuitry is disposed corresponding to a cathode of the MEA, and the first contact electrically is connected to the cathode current collection circuitry, thereby a cathode current collection plate is fabricated. A step is to form at least an anode current collection circuitry and at least a second contact on the same surface of the anode substrate, wherein the anode current collection circuitry is disposed corresponding to an anode of the MEA, and the second contact is electrically connected to the anode current collection circuit.

### FIELD OF THE INVENTION

The present invention relates to a method of fabricating a fuel cell, and more particularly, to the method of forming serial or parallel fuel cell units, by which specific fuel cells with different supplied voltages and currents are easily fabricated.

### BACKGROUND OF THE INVENTION

Prior arts about fuel cells mostly describe the structure of fuel cells or membrane electrode assembly (MEA) layers, or merely disclose methods to form current collection layers and the structure thereof using graphite or metallic meshes. Such current collection layers may function well, but the methods that utilize graphite or metallic meshes inherently limit the design of serial and parallel circuits and fuel control circuits. Hence, conventional methods do not meet the requirements for compact fuel cells.

Besides, the serial and parallel circuits of a conventional fuel cell made from a printed circuit board are conducted by via holes. The via holes may be formed after integrating an anode current collection layer, MEAs, and a cathode current collection layer to a single-piece structure. Or, The via holes may be formed on an anode current collection layer or a cathode current collection layer, and then integrated with MEAs. These ways both need the process of forming via holes, and have more cost and lower production yield. In addition, the condition of high temperatures and used solvents in the via hole process may damage MEAs, influencing the efficiency of fuel cells.

Therefore, a method of forming serial or parallel fuel cell units is provided to overcome the aforesaid disadvantages, by which specific fuel cells with different supplied voltages and currents are easily fabricated.

### SUMMARY OF THE INVENTION

It is a primary object of the invention to provide a method of forming serial or parallel fuel cell units, which utilizes printed circuit board (PCB) processes to fabricate specific fuel cells with different supplied voltages and currents.

It is another object of the invention to provide a method of forming serial or parallel fuel cell units without the via holes, to fabricate the fuel cells with different supplied voltages and currents.

In accordance with the objects of the invention, a method of forming serial or parallel fuel cell units is provided, comprising the steps of: (a) providing a cathode substrate, an anode substrate and at least a MEA; (b) forming at least a cathode current collection circuitry and at least a first contact on the same surface of the cathode substrate, wherein the cathode current collection circuitry is disposed corresponding to a cathode of the MEA, and the first contact electrically is connected to the cathode current collection circuitry, thereby a cathode current collection plate is fabricated; (c) forming at least an anode current collection circuitry and at least a second contact on the same surface of the anode substrate, wherein the anode current collection circuitry is disposed corresponding to an anode of the MEA, and the second contact is electrically connected to the anode current collection circuitry, thereby an anode current collection plate is fabricated; and (d) stacking the cathode current collection plate, the MEAs and the anode current collection plate from top to bottom, to form a single-piece structure, wherein each fuel cell unit comprises one cathode current collection circuitry, one MEA and one anode current collection circuitry, and each first contact respectively contacts with a corresponding second contact, therefore the fuel cell unit is electrically connected to another fuel cell unit in serial and/or parallel.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a flow chart of forming a serial or parallel fuel cell unit of the invention;

FIG. 2 is the exploded view of a fuel cell fabricated by the method of the invention;

FIG. 3 is the cross section of a fuel cell in FIG. 2; and

FIG. 4 is an exploded view of a fuel cell according to another embodiment of the invention.

### DETAILED DESCRIPTION OF THE INVENTION

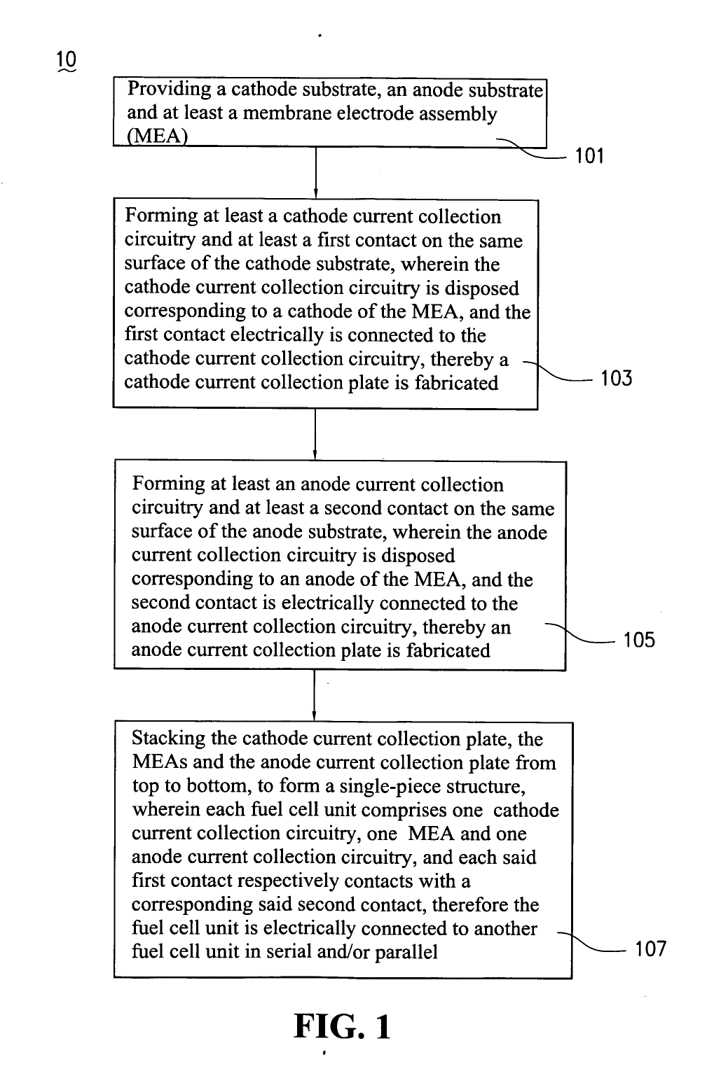

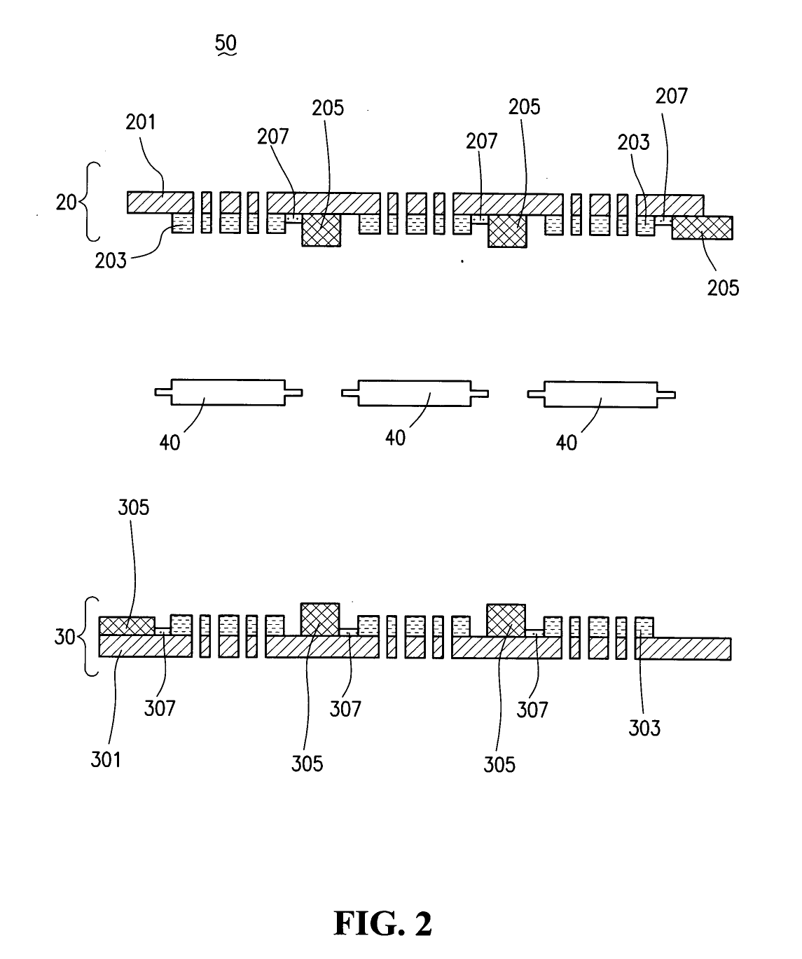

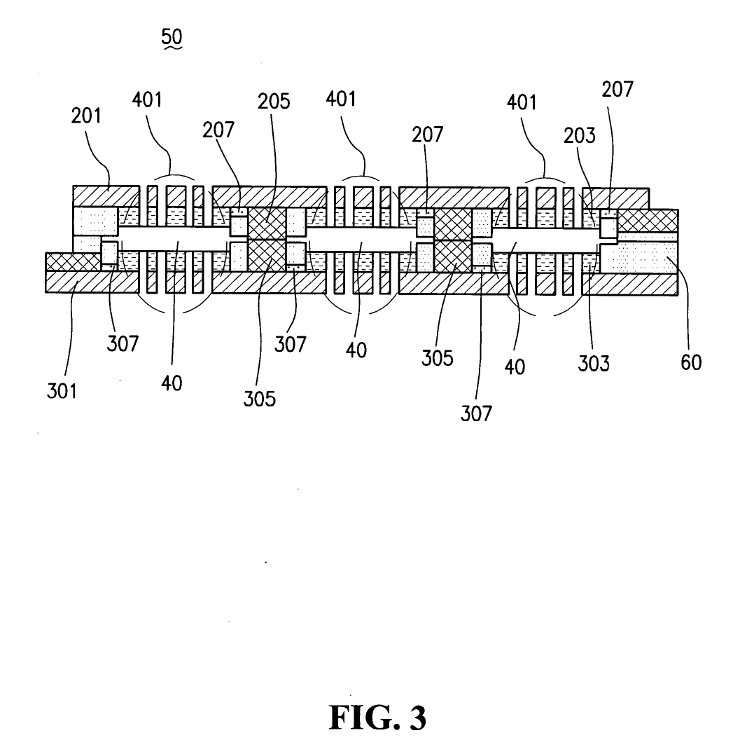

FIG. 1 is a flow chart of forming a serial or parallel fuel cell unit of the invention, FIG. 2 is the exploded view of a fuel cell fabricated by the method of the invention, and FIG. 3 is the cross section of a fuel cell in FIG. 2. The method 10 of forming serial or parallel fuel cell units comprises the steps 101, 103, 105 and 107, which is separately described hereinafter. In step 101, there are a cathode substrate 201, an anode substrate 301 and at least a membrane electrode assembly (MEA) 40. For example, the based material of the cathode substrate 201 and the anode substrate 301 may utilize the printed circuit board (PCB), a ceramic substrate, or a polymer plastic substrate. The MEA 40 could be a MEA using solid fuels, gaseous fuels or liquid fuels.

In step 103, at least a cathode current collection circuitry 203 and at least a first contact 205 are formed on the same surface of the cathode substrate 201. Each cathode current collection circuitry 203 is disposed corresponding to a cathode of the MEA 40. Each first contact 205 is electrically connected to a corresponding cathode current collection circuitry 203. A cathode current collection plate 20 is fabricated after performing step 103.

In step 105, at least an anode current collection circuitry 303 and at least a second contact 305 are formed on the same surface of the anode substrate 301. Each anode current collection circuitry 303 is disposed corresponding to an anode of the MEA 40. Each second contact 305 is electrically connected to a corresponding anode current collection circuitry 303. An anode current collection plate 30 is fabricated after performing step 105.

In steps 103 and 105, the first contacts 205 and the second contacts 305 are fabricated, for example, by means of selecting one of deposition, sputter, print, plaster, or forming a conductive layer on the cathode substrate 201 and the anode substrate 301 and then laser cutting or etching the conductive layer, thereafter, with one of the aforesaid means, the chemical-resistant metallic conductive material or non-metallic conductive material formed respectively on the surface of the cathode substrate 201 and the surface of the anode substrate 301. Similarly, the cathode current collection circuitries 203 and the anode current collection circuitries 303 may be formed by the same fabricate way of the first contacts 205 and the second contacts 305.

Furthermore, in steps 103 and 105, the first conducting wires 207 and the second conducting wires 307 are formed on the cathode substrate 201 and the anode substrate 301, respectively. Each first conducting wire 207 is connected to corresponding first contact 205 and cathode current collection circuitry 203. Each second conducting wire 307 is connected to corresponding second contact 205 and anode current collection circuitry 303. Similarly, as mentioned before, the first conducting wires 207 and the second conducting wires 307 may be formed by the same fabricate way of the first contacts 205 and the second contacts 305.

In step 105, the cathode current collection plate 20, the MEAs 40 and the anode current collection plate 30 are stacked from top to bottom, to form a sealed single-piece structure. Thereafter, each fuel cell unit 401 comprises one cathode current collection circuitry 203, one MEA 40 and one anode current collection circuitry 303. Therefore, each first contact 205 contacts with corresponding second contact 305. Accordingly, the fuel cell unit 401 is electrically connected to another fuel cell unit 401 in serial and/or in parallel. Further, in step 105, a pad 60 is used to ensure the sealed single-piece structure.

FIG. 2 and FIG. 3 illustrate a fuel cell 50, utilizing the fuel cell units 401 are connected in serial through the first contacts 205 and the second contacts 305.

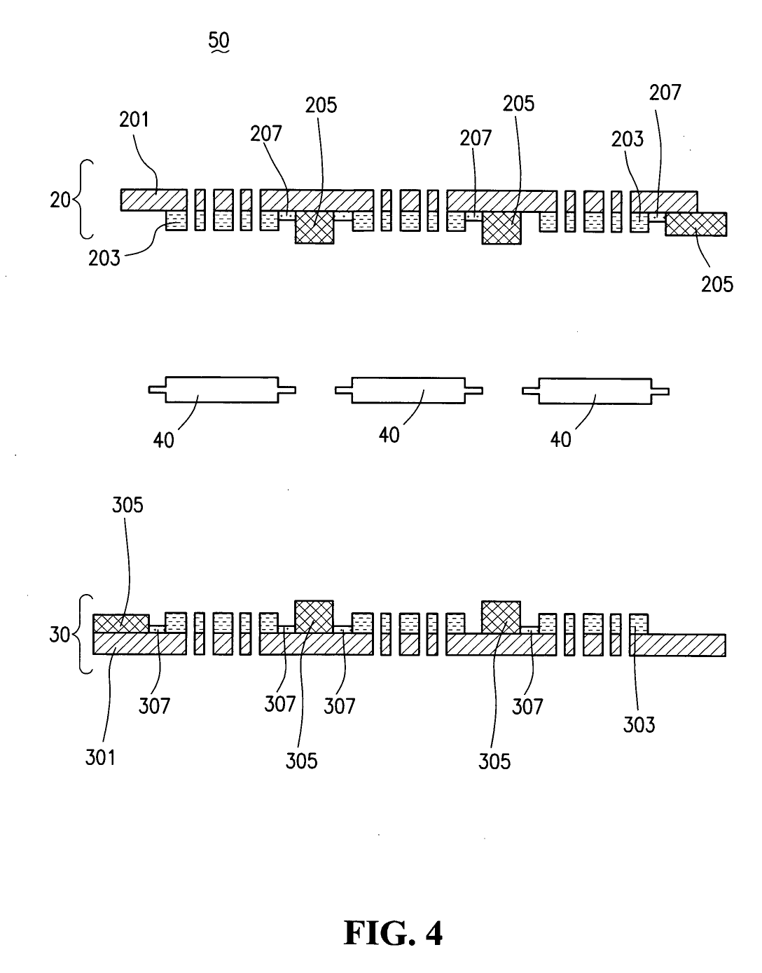

FIG. 4 is an exploded view of a fuel cell according to the method of the invention, the fuel cell 50 as shown in FIG. 4, utilizing fuel cell units 401 are connected in parallel through the first contacts 205 and the second contacts 305.

The fuel cells in FIGS. 2,3, and 4 are only exemplars to clarify the method 10, which are not intended to limit the invention. The fuel cell units 401 of the fuel cell 50 may be deployed in serial, in parallel, or in combination thereof by means of the method 10.

There are at least some advantages in the present, as follows:

1. It is economical due to low production and material cost.

2. It is suitable for mass production.

3. It requires simple surrounding systems.

4. Its resultant structure has low circuitry resistance.

5. Its resultant structure occupies less space.

6. It can be applied to different specifications of voltages and currents.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method of forming serial or parallel fuel cell units, the method comprising the steps of:
(a). providing a cathode substrate, an anode substrate and at least a membrane electrode assembly (MEA);
(b). forming at least a cathode current collection circuitry and at least a first contact on the same surface of the cathode substrate, wherein the cathode current collection circuitry is disposed corresponding to a cathode of the MEA, and the first contact electrically is connected to the cathode current collection circuitry, thereby a cathode current collection plate is fabricated;
(c). forming at least an anode current collection circuitry and at least a second contact on the same surface of the anode substrate, wherein the anode current collection circuitry is disposed corresponding to an anode of the MEA, and the second contact is electrically connected to the anode current collection circuitry, thereby an anode current collection plate is fabricated; and
(d). stacking the cathode current collection plate, the MEAs and the anode current collection plate from top to bottom, to form a single-piece structure, wherein each fuel cell unit comprises one said cathode current collection circuitry, one said MEA and one said anode current collection circuitry, and each said first contact respectively contacts with a corresponding said second contact, therefore the fuel cell unit is electrically connected to another fuel cell unit in serial and/or parallel.

2. The forming method according to claim 1, wherein the step (b) further comprises: forming at least a first conducting wire on the cathode substrate disposed on the same surface of the cathode collection circuitries, wherein each said first conducting wire is connected to a corresponding said first contact and a corresponding said cathode current collection circuitry.

3. The forming method according to claim 1, wherein the step (c) further comprises: forming at least a second conducting wire on the anode substrate disposed on the same surface of the anode collection circuitries, wherein each said second conducting wire is connected to a corresponding said second contact and a corresponding said anode current collection circuitry.

4. The forming method according to claim 1, wherein the material of the cathode substrate is a printed circuit board, a ceramic substrate, or a polymer plastic substrate.

5. The forming method according to claim 1, wherein the material of the anode substrate is a printed circuit substrate, a ceramic substrate, or a polymer plastic substrate.

6. The forming method according to claim 1, wherein a material of the first contact is a metallic conductive material or a non-metallic conductive material.

7. The forming method according to claim 1, wherein a material of the second contact is a metallic conductive material or a non-metallic conductive material.

8. The forming method according to claim 1, wherein in step (b), the first contacts are fabricated by means of selecting one of deposition, sputter, print, plaster, or forming a conductive layer on the cathode substrate and then laser cutting or etching the conductive layer.

9. The forming method according to claim 1, wherein in step (c), the second contacts are fabricated by means of selecting one of deposition, sputter, print, plaster, or forming a conductive layer on the anode substrate and then laser cutting or etching the conductive layer.

10. The forming method according to claim 1, wherein the fuel cell unit utilizes solid fuels.

11. The forming method according to claim 1, wherein the fuel cell unit utilizes gaseous fuels.

12. The forming method according to claim 1, wherein the fuel cell unit utilizes liquid fuels.
